(19) United States
(12) Patent Application Publication
(10) Pub. No.: US 2026/0360207 A1
(43) Pub. Date: Nov. 12, 2026

(54) GAMING SYSTEMS AND METHODS WITH VARIABLE BONUS ENHANCEMENT FEATURE

(71) Applicant: LNW Gaming, Inc., Las Vegas, NV (US)

(72) Inventor: Bryan VANDAELE, Cedar Falls, IA (US)

(21) Appl. No.: 19/204,998

(22) Filed: May 12, 2025

(51) Int. Cl. G07F 17/32; G07F 17/34

(52) U.S. Cl. CPC G07F 17/3213; G07F 17/3267; G07F 17/34

(57) ABSTRACT

There is provided gaming systems, machines, and methods that utilize a presentation assembly configured to present symbol positions and enhancement meters associated with a respective update trigger event type and a respective game enhancement. The presentation assembly presents base game outcomes, and, in response to an update trigger event occurring, visually updates, the meter indicia of the associated meter. In response to a bonus trigger event occurring, the presentation assembly visually transitions a bonus game instance including bonus game outcomes with instance any active enhancement meters. At least one bonus game outcome is randomly selected for each active meter to apply the corresponding game enhancement as a function of a value visually indicated by the meter. For each bonus game outcome with an applied active meter, the presentation assembly presentations an outcome sequence including the game enhancement of the applied meter and visually updates the indicia of the applied meter.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

### FIELD OF THE INVENTION

The present invention relates to a technological improvement to gaming systems, gaming machines, and methods and, more particularly, to new and improved animations in connection with a variable bonus enhancement feature.

### BACKGROUND OF THE INVENTION

The gaming industry depends upon player participation. Players are generally “hopeful” players who either think they are lucky or at least think they can get lucky-for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

Conventional electronic gaming machines often present players with complex game states, particularly when transitioning between base game play and bonus features involving persistent or accumulated player-specific advantages. A technical challenge exists in clearly and intuitively conveying to the player the status of these persistent advantages between game features and how game events presented within a base game feature will impact a forthcoming bonus feature without cluttering the game interface or requiring the player to navigate complex help screens. Existing graphical interfaces do not adequately represent the accumulation of potential bonus enhancements in a way that is both easily understandable and visually engaging during base gameplay. Furthermore, the transition into a bonus game instance, the application of such enhancements during the bonus game instance, and the subsequent return to the base game feature often lack clear, animated visual cues that link these phases cohesively, potentially leading to player confusion regarding the value and effect of their accumulated progress. There is a need for improved graphical game interfaces and animation sequences that provide a more intuitive visual representation of how game enhancements are accrued, activated, and depleted, thereby enhancing the player's understanding and engagement with the game's mechanics through a specific technological implementation of the graphical game presentation.

### SUMMARY OF THE INVENTION

According to an embodiment of the present invention, there is provided a gaming system, gaming machine, and method that utilize game-logic circuitry in communication with a presentation assembly configured to present a graphical game interface including a plurality of symbol positions and a plurality of enhancement meters, wherein each of the enhancement meters is associated with a respective update trigger event type and a respective game enhancement and includes meter indicia visually indicating a current meter value. The game-logic circuitry, via the presentation assembly, presents one or more base game outcomes by populating, via animation of the graphical game interface, the plurality of symbol positions with randomly selected symbols, visually updates, in response to one or more update trigger events occurring within the base game outcomes, the meter indicia of the enhancement meter of the plurality of enhancement meters that is associated with each update trigger event, and visually transitions, in response to a bonus trigger event occurring within the base game outcomes, the graphical game interface to a bonus game state for a bonus game instance including a plurality of bonus game outcomes, the bonus game instance incorporating any active enhancement meter. The game-logic circuitry randomly selects, for each active enhancement meter, at least one bonus game outcome to apply the corresponding game enhancement at least partially as a function of the meter indicia of the active enhancement meter and one or more random values generated by a continuously-cycling random number generator of the game-logic circuitry. The game-logic circuitry further causes, for each bonus game outcome associated with one or more active enhancement meters based on the random selection, the presentation assembly to (i) present an outcome sequence including animations associated with the game enhancements of the one or more active enhancement meters, and (ii) visually update the respective meter indicia of the one or more active enhancements in response to the outcome sequence. The game-logic circuitry may be separate from a gaming machine including the presentation assembly or at least partially integrated within the gaming machine.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine, according to one or more embodiments of the present disclosure.

FIG. 2 is a block diagram of a gaming system, according to one or more embodiments of the present disclosure.

FIG. 3 is a flow diagram of an example method of operating a gaming machine, according to one or more embodiments of the present disclosure.

FIG. 4 is an example game interface for a gaming system, according to one or more embodiments of the present disclosure.

FIG. 5A is an example game interface of a gaming system in a base game state with an update trigger event, according to one or more embodiments of the present disclosure.

FIG. 5B is the game interface shown in FIG. 5A in a second state with updated enhancement meters responsive to the update trigger event, according to one or more embodiments of the present disclosure.

FIG. 5C is the game interface shown in FIG. 5A in a third state with a bonus trigger event, according to one or more embodiments of the present disclosure.

FIG. 5D is the game interface shown in FIG. 5A in a fourth state after a transition to a bonus game state and including a bonus game outcome, according to one or more embodiments of the present disclosure.

FIG. 5E is the game interface shown in FIG. 5A in a fifth state including the game enhancement indicated in FIG. 5D, according to one or more embodiments of the present disclosure.

FIG. 5F is the game interface shown in FIG. 5A in a sixth state at the conclusion of a bonus game, according to one or more embodiments of the present disclosure.

FIG. 5G is the game interface shown in FIG. 5A in a seventh state following a transition to the base game state and with the enhancement meters reset, according to one or more embodiments of the present disclosure.

FIG. 6 is a table depicting an example bonus game sequence with enhancement meters, according to one or more embodiments of the present disclosure.

FIG. 7 is an example game interface of a gaming system according to an example game theme, according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

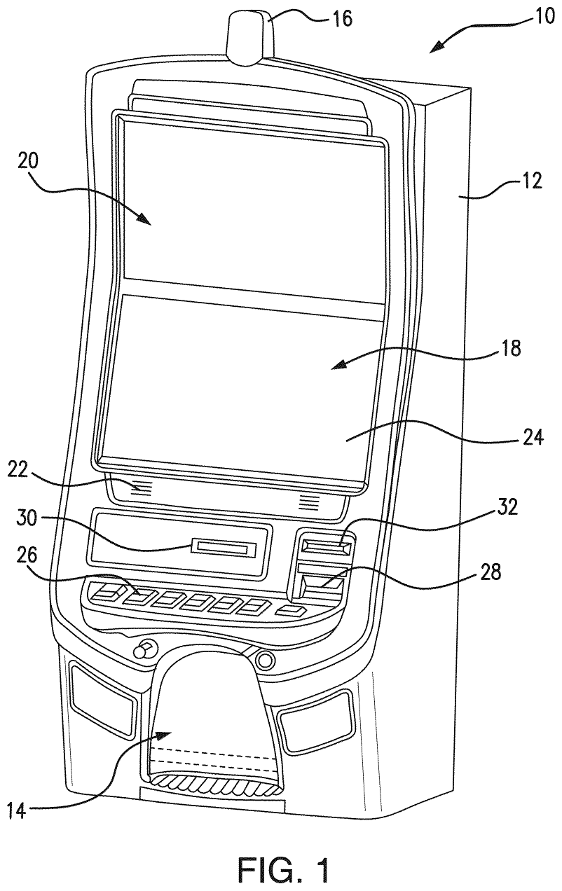

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

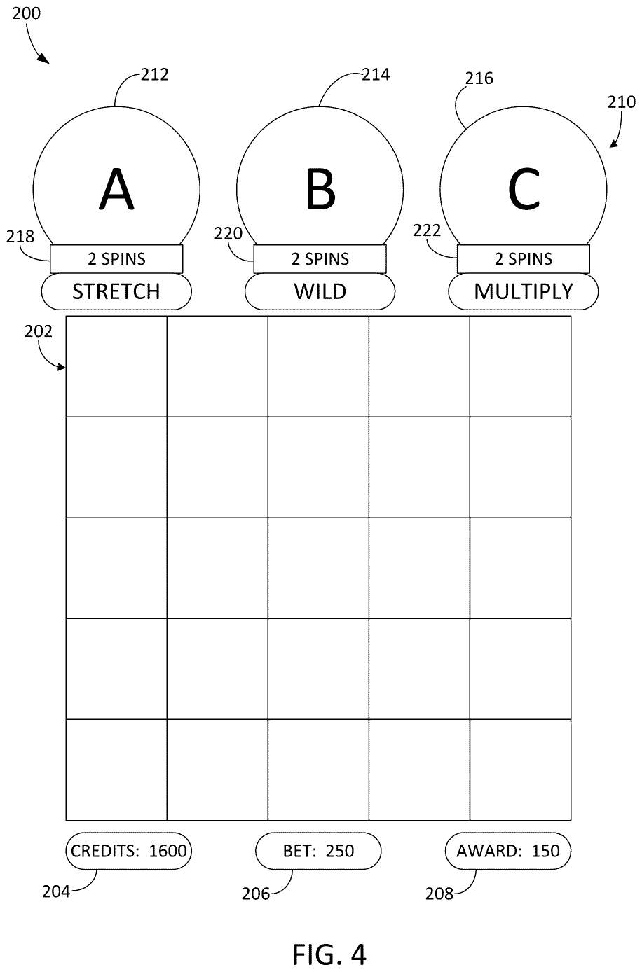

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 204 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 204 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

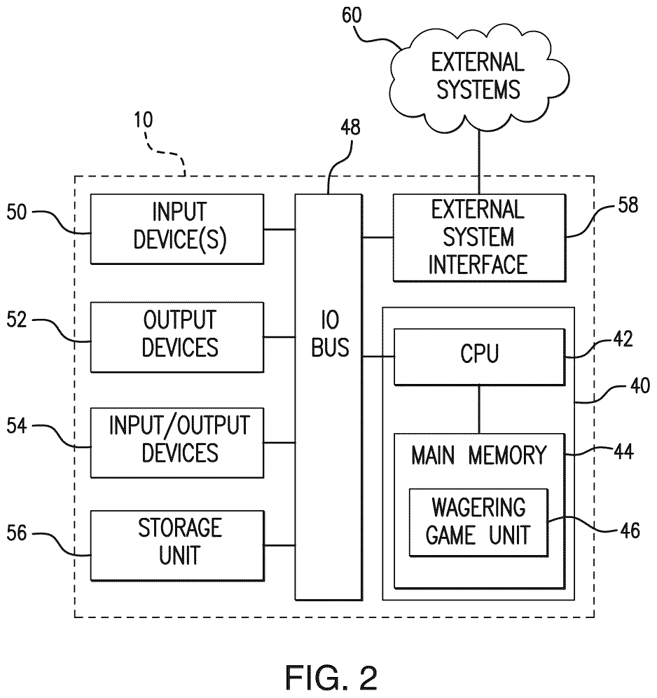

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success, and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

The following gaming systems and methods described herein include one or more game features associated with enhancement meters. Enhancement meters are graphical elements presented within a game interface that are associated with one or more game enhancements. As used herein, a “game enhancement” is an alteration to underlying game-logic and/or game functionality that provides a perceived enhancement to the game feature. The perceived enhancement provides an advantage (e.g., increased awards, increased odds of achieving a winning condition, enhanced potential awards, increased playing field, etc.) relative to standard play of the game feature. The game enhancements may include, but are not limited to, additional symbol positions, additional special symbols (e.g., wild symbols), upgraded symbols, modifiers, guaranteed award events, activation or enhancements of additional game elements (e.g., an award wheel or prize board), unlocked jackpot prizes, special game feature triggers, meter value modifications, and/or the like.

Each enhancement meter monitors a value corresponding to the game enhancement, where the game enhancement is appliable to the game feature selectively based on the current value of the enhancement meter. In one example, the meter value indicates a number of game outcomes that the enhancement meter can be applied. In another example, the meter value indicates a number of game enhancements that can be applied to the game feature (e.g., if the current meter value is four for a meter associated with wild symbol enhancement, then four wild symbols can be selectively applied to the game feature, including all four wild symbols within a single game outcome). As used herein, an “active enhancement meter” is an enhancement meter with a current meter value that is within a range of values that indicate the corresponding game enhancement can be selectively applied to the game feature, and, conversely, an “inactive enhancement meter” has a meter value that is outside of this predefined range of values. In at least some embodiments, an active enhancement meter has a nonzero meter value. In some embodiments, an enhancement meter may be required to overcome a nonzero threshold before the meter is considered to be active. In certain embodiments, additional or alternative parameters and conditions may be used to determine the active or inactive state of a given enhancement meter. In one example, a symbol or combination of symbols within the game feature or a wagering threshold (for wagering games) may be required to activate an enhancement meter.

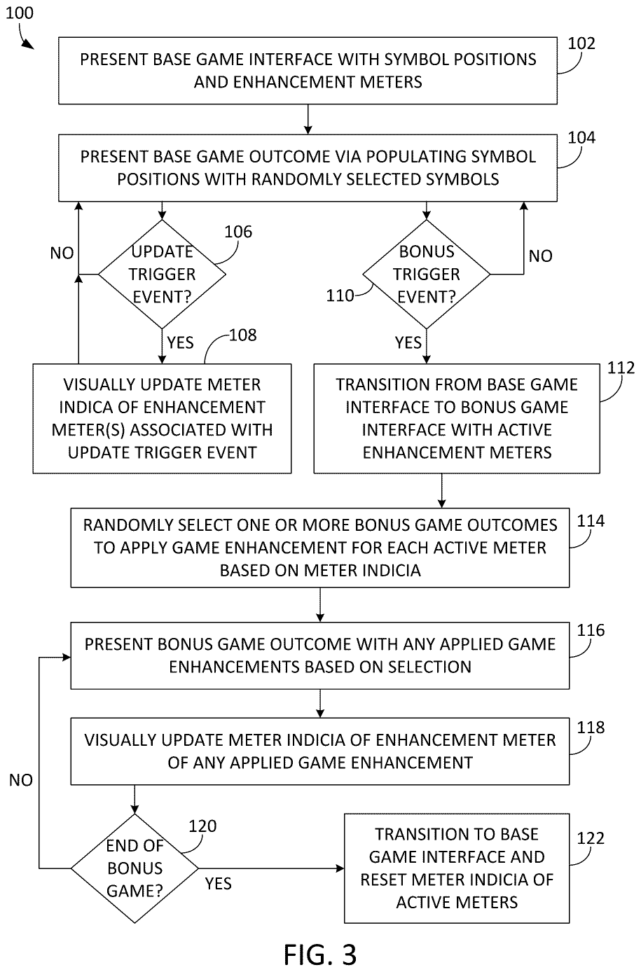

FIG. 3 depicts a flow diagram of an example method 100 for operating a gaming machine of a gaming system, such as the machine 10 shown in FIGS. 1 and 2. The method 100 is performed via game-logic circuitry of the gaming system and a presentation assembly of the gaming machine. The game-logic circuitry may be separate from the gaming machine or at least partially integrated within the gaming machine. In other embodiments, the method 100 includes additional, fewer, or alternative steps and/or is performed via a different configuration of devices within the gaming system, including steps and devices described elsewhere herein.

The method 100 is associated with one or more games hosted or conducted by the gaming machine. To play the one or more games, a player initiates a gaming session at the gaming machine. More specifically, the player provides manual input at the gaming machine and/or other suitable inputs to indicate the intent to begin a gaming session. In one example, the player may provide input that identifies the player to the gaming machine and/or a player account system in communication with the gaming machine. The input may be the player manually entering credentials to the gaming machine, providing a physical input associated with the player's identity, and/or a computing device associated with the player communicating with the gaming machine and/or the player account system. For wagering game embodiments, the player input may include providing a credit input to the gaming machine or an accounting system in communication within the gaming machine. The credit input, similar to the player identification, may be one or more physical credit inputs (e.g., coins, bills, tickets, cards, etc.) and/or a digital credit input, such as linking a digital wallet of the player to the gaming session.

In response to establishing a gaming session at the gaming machine, a presentation assembly of the gaming machine is configured to present a graphical game interface in a base game state. It is to be understood that the “graphical game interface” referred to herein is at least partially presented via one or more graphical display devices and may additionally include other suitable visual presentation devices, such as mechanical spinning reel strips, emotive lighting, and the like. The graphical game interface is presentable in one or more presentation states that correspond to different game features of an underlying game. In the example embodiment, the game includes at least a base game feature and a bonus game feature that is selectively initiated from the base game feature as described herein. In other embodiments, the game includes additional, fewer, or alternative game features. In one example, the game includes a single game feature, and at least a portion of the functionality associated with the bonus game feature as described herein may be incorporated into and adapted to the base game feature.

At step 102, in response to initiating the gaming session to play the game, the game-logic circuitry causes the presentation assembly to present a graphical base game interface with a plurality of symbol positions and enhancement meters. The symbol positions are graphical elements in which symbols selectively populate as described herein. The plurality of symbol positions may be arranged into one or more groups of positions, such as a symbol array. The symbol array is formed by organizing the symbol positions into rows and columns. In other embodiments, the symbol positions may take other suitable visual forms, and/or other suitable graphical game elements may be used to visually depict the random selections forming game outcomes as described herein. In one example, symbol-bearing wheels may be animated to spin (or spin a corresponding selector) to select one or more symbols for a game outcome.

The enhancement meters are graphical game elements associated with respective game enhancements that are applied to the bonus game feature as described herein. The game enhancements modify the game functionality of the bonus game feature to provide a potential positive benefit to the player, such as, and without limitation, adding wild symbols to a game outcome, adding symbol positions, removing lower-valued symbols, adding jackpot trigger symbols, and the like. The enhancement meters include visual meter indicia that monitor one or more values associated with the respective game enhancement as described herein. In some embodiments, additional graphical elements are associated with each enhancement meter. For example, each enhancement meter may be associated with a respective avatar that is selectively animated in response to changes to the enhancement meter and/or activation of the corresponding game enhancement as described herein.

At step 104, the base game feature is conducted and presented. More specifically, the game-logic circuitry is configured to generate a base game outcome and cause the presentation assembly to present an outcome sequence for the base game outcome including selectively populating the symbol positions with randomly selected symbols. The base game outcome is generated by the game-logic circuitry generating, via a continuously-cycling random number generator of the game-logic circuitry (or other suitable random determination mechanism) one or more random values or other random elements that are comparable to one or more sets of available symbols to select the populating symbols. The sets of available symbols may be symbol-bearing reel strips associated with one or more symbol positions. In some embodiments, each set of available symbols is stored in or otherwise associated with a weighted table for symbol selection. That is, each symbol, reel stop position, or other element that defines which symbols are selected for a game outcome are associated with one or more weight parameters. The weight parameters at least partially define the relative probabilities of selecting a given symbol over other symbols within the set of available symbols. The weight parameters are formatted to facilitate comparison with the random values (and/or other randomly-generated data) from the RNG unit of the game-logic circuitry. For example, each weight parameter may be a range or set of values within a total addressable range of the random value generation of the RNG unit, and the randomly generated value is compared to the weighted table to identify (and select for the game outcome) which symbol or reel stop position associated with the weight parameter that includes the randomly generated value. Additional or alternative steps may be used to incorporate the random data generation with the symbol selection according to the particular configuration of the gaming machine, regulatory requirements, and/or other suitable environmental parameters of the gaming system.

In response to the base game outcome being generated, the presentation assembly is configured to present a corresponding outcome sequence. The outcome sequence includes one or more animations and/or visual updates to the base game interface to visually indicate to the player that an outcome has been generated. The outcome sequence may additionally include other sensory outputs, such as audio outputs, emotive lighting outputs, and/or tactile outputs, to aid the visual presentation via the base game interface. In one example, the outcome sequence includes graphically animating the reel strips to spin and stop on the symbols forming the base game outcome. In another example, symbols from the sets of available symbols are animated to “cycle” through the symbol positions without reels strips, and the cycle animation concludes with the selected symbols in the symbol positions. It is to be understood that the game outcomes described herein and, by extension, the corresponding outcome sequences, may include “blanks” that represent the absence of a symbol within the symbol position. In at least some embodiments, these blanks may be treated by the game-logic circuitry similar to the symbols (i.e., a weight parameter is assigned and compared to the random values for symbol selection).

The game-logic circuitry is configured to perform one or more outcome determinations for each game outcome. The outcome determinations compare the current state of the game elements (including the randomly selected symbols) to stored, predefined parameters and/or functions to identify particular game events and execute corresponding actions. Steps 106 and 110, as described herein, are two example outcome determinations. The outcome determinations may be processed by the game-logic circuitry sequentially, in parallel, or according to the available computing resources available to the game-logic circuitry. The outcome determinations may be incorporated into one or more presentation sequences of the presentation assembly, including the outcome sequence. It is to be understood that the game-logic circuitry may be configured to generate the base game outcome and perform the corresponding outcome determinations prior to the presentation assembly presenting the outcome sequence.

In some embodiments, the output of one outcome determination is applied to or otherwise factored into another outcome determination. For example, although steps 106 and 110 are shown in FIG. 3 to be processed separately from each other, the game-logic circuitry may not proceed with the determination at step 110 until the determination and resulting action of step 106 is completed to ensure any changes from step 106 are incorporated into step 110 and the corresponding actions.

At step 106, the game-logic circuitry determines whether or not an update trigger event is present within the base game outcome. An update trigger event is a game event that indicates one or more of the enhancement meters should be updated. In some embodiments, the update trigger event is the presence of a particular trigger symbol or trigger combination of symbols. In one example, each trigger symbol is an independent update trigger event. In another example, the trigger symbols may be collectively associated with a single update trigger event for each linked enhancement meter and/or for all of the enhancement meters. The update trigger symbols may include visual indicia and/or other visual characteristics that indicate to the player a relationship between the trigger symbols and any corresponding enhancement meters. In one example, the enhancement meters are associated with a respective color, and the corresponding update trigger symbols include the respective color to visually link the symbols and meters together. In another example, the update trigger symbols include visual characteristics associated with one or more avatars of the enhancement meters. In certain embodiments, the link between trigger symbols and enhancement meters may not be persistently defined. That is, the trigger symbols may be selectively linked to the enhancement meters in response to one or more game events or conditions, such as player selection of one or more enhancement meters or a random selection visually indicated through another game presentation element (e.g., a wheel) and/or visual changes to the game interface.

In other embodiments, the update trigger event may include additional or alternative conditions, events, and/or parameters to be activated. For example, the update trigger event may not be registered until the player has achieved a wagering condition associated with the gaming session and/or a player account linked to the player's historical gaming sessions. In certain embodiments, the update trigger event may include one or more random determinations beyond the random determinations for generating the base game outcome. For example, in response to an update trigger symbol being detected in the base game outcome, a random determination is performed to determine whether or not the update trigger event occurs. In such embodiments, if the random determination indicates an update trigger event did not occur, the presentation assembly may still present a presentation sequence associated with the one or more enhancement meters associated with the inactive update trigger event to visually indicate to the player that the update trigger event was detected. For example, the inactive update trigger event may cause the presentation assembly to present a visual change or animation to the avatar of a linked enhancement meter, including visual changes the persistent for one or more subsequent game outcomes (i.e., perceived persistence). In some embodiments, the probability of activating the update trigger event is greater at lower meter values relative to higher meter values to create a perceived increasing challenge to reach higher meter values. The variable probability may be determined on a per-meter basis or through collective monitoring of the meters. The variable probability may be implemented, for example, by adjusting one or more weight parameters associated with the random determination based on the current state of each meter.

If no update trigger event is detected (or all detected update trigger events are determined to be inactive), the game-logic circuitry continues to complete any remaining outcome determinations for the base game outcome before proceeding to the next base game outcome at step 104. However, if an update trigger event is detected, the method 100 proceeds to step 108. More specifically, at step 108, the game-logic circuitry causes the presentation assembly to visually update meter indicia of the one or more enhancement meters associated with the update trigger event. The visual update may be configured to reflect a stored value that the game-logic circuitry updates in response to the update trigger event. In at least some embodiments, the meter indicia is incremented towards a maximum meter value in response to the update trigger event. In other embodiments, the meter value (and, by extension, the meter indicia) is updated in response to the update trigger event through additional or alternative mathematical and/or logical operations. In some embodiments, the change to the meter value is at least partially a function of one or more parameters of the update trigger event. For example, the meter value may be incremented for every update trigger symbol forming the update trigger event.

Following step 108, the game-logic circuitry completes any remaining outcome determinations for the base game outcome before proceeding to the next base game outcome at step 104. In the example embodiment, the game-logic circuitry performs the determination at step 110 following steps 106 and 108. More specifically, the game-logic circuitry determines whether or not a bonus trigger event is present and active in the base game outcome at step 110. The bonus trigger event may include, for example, one or more bonus trigger symbols occupying the symbol positions. The bonus trigger symbols may be different from the update trigger symbols, or the same symbols may function as both update and bonus trigger symbols. It is to be understood that the update and/or bonus trigger symbols may include additional functionality within the base game, such as functioning as wild symbols for determining winning symbol combinations. Multiple types of bonus trigger events may be achievable within the base game feature. For example, if all (or some) enhancement meters reach the respective maximum meter values, the bonus trigger event is automatically active.

Similar to the update trigger event, if no bonus trigger event is detected at step 110, the game-logic circuitry performs any remaining outcome determinations and proceeds to the next base game outcome at step 104. However, if a bonus trigger event is detected, the method 100 proceeds to step 112. At step 112, a bonus game instance is initiated, and the presentation assembly is configured to transition the base game interface to a bonus game interface via a transition sequence. The transition sequence includes one or more visual updates and animations to visually indicate the start of the bonus game instance to the player and to adjust or add any game presentation elements within the game interface to facilitate the functionality of the bonus game feature. For example, the symbol positions from the base game state may remain in the bonus game state, or new, additional, fewer, or alternative bonus symbol positions are provided during the bonus game state.

The bonus game instance includes one or more active enhancement meters. The active enhancement meters may initially include, for example, every enhancement meter, every enhancement meter with a nonzero meter value, a subset of the enhancement meters associated with the bonus trigger event and/or a random determination by the game-logic circuitry (e.g., randomly selecting one or more enhancement meters for the bonus game instance via the RNG unit). The presentation of the active enhancement meters may be visually distinct from inactive enhancement meters. As described herein, the difference between the active and inactive enhancement meters within a bonus game instance is defined by whether or not the corresponding enhancement can be applied to the current or subsequent bonus game outcomes. The visually distinct characteristics between active and inactive enhancement meters may include, for example, highlighting the active enhancement meters, greying out or increasing the transparency of the inactive enhancement meters, visually altering the corresponding avatars, and the like. In certain embodiments, the inactive enhancement meters are removed or hidden from the bonus game interface.

In the example embodiment, the bonus game instance is initiated with a predefined duration. The predefined duration may be a number of bonus game outcomes. In some embodiments, the duration of the bonus game instance may be dynamic. That is, game events occurring within the bonus game instance may reduce or increase the remaining duration of the bonus game instance. In certain embodiments, the duration of the bonus game instance is at least partially a function of the bonus trigger event. In one example, the number of bonus trigger symbols detected changes the duration of the bonus game instance. In another example, the highest meter value accumulated through the base game determines, either directly or as a function including one or more additional parameters (e.g., a random value), the duration of the bonus game instance. In the example embodiment with the predefined duration and meter indicia indicating a number of game outcomes as described herein, the meter values of the enhancement meters can be increased or otherwise improved up to a value equal to the duration of the bonus game instance such that a meter with a maximum meter value is applied to each and every outcome of the bonus game instance.

At step 114, the game-logic circuitry is configured to randomly select one or more bonus game outcomes to apply the game enhancement of each active enhancement meter based on the respective meter indicia. For example, if a first enhancement meter has a meter value of five at the beginning of the bonus game instance, then the game enhancement of the first enhancement meter is randomly applied to five bonus game outcomes of the bonus game instance. In another example, the meter value may indicate a number of enhancement applications such that multiple instances of the game enhancement may be applied to a single bonus game outcome. In some embodiments, particularly embodiments with predefined bonus game durations, step 114 is done prior to determining the bonus game outcomes. In other embodiments, step 114 may be performed between each bonus game outcome to determine whether or not the next bonus game outcome has any game enhancements to be applied. In such embodiments, the remaining duration of the bonus game instance and the current meter value of an active enhancement meter may match such that the game enhancement is automatically applied to each remaining bonus game outcome.

The random selection includes one or more random values generated by the continuously cycling random number generator of the game-logic circuitry in combination with the meter value. For example, the meter value may indicate the number of total random selections or the remaining number of selections available. In some embodiments, the meter value may represent a value other than an amount of random selections, and the meter value may be incorporated within the random selection and/or game enhancement. In one example, the meter value may represent a credit value that is distributed among the randomly selected game outcomes for use with the corresponding game enhancement. The random selection may include any suitable mathematical and/or logical operations that facilitate the determinations. In one example, the random selection is similar to the random selection of symbols in game outcomes by assigning different outcomes of the selection to one or more possible random values that can be generated by the RNG unit of the game-logic circuitry.

In the example embodiment, the game-logic circuitry generates a bonus game outcome by randomly selecting symbols to selectively populate the bonus symbol positions and, at step 116, causes the presentation assembly to present the bonus game outcome via an outcome sequence. For example, the presentation assembly may present a spinning animation that cycles available symbols through the symbol positions before stopping on the symbols (which may include “blanks”) representing the bonus game outcome. Based on the random selection at step 114, one or more game enhancements may be applied to the bonus game outcome. The game-logic circuitry incorporates the applied game enhancements according to the stored, predefined instructions associated with the game enhancement to the bonus game outcome. For example, if the game enhancement adds wild symbols to the bonus game outcome, the wild symbols are applied to the symbol positions prior to the game-logic circuitry performing outcome determinations for any winning symbol combinations to ensure the wild symbols are appropriately considered for any achieved awards.

At step 118, the presentation assembly animates or otherwise visually updates the meter indicia of any enhancement meter associated with an applied game enhancement for the current bonus game outcome. In particular, the meter indicia is updated to advance towards an inactive threshold. In one example, the meter indicia is decremented at step 118 to visually indicate the number of applications of the corresponding game enhancement remains for the current bonus game instance. The outcome sequence at step 116 may include one or more additional animations and/or visual updates associated with the enhancement meter (or associated graphical elements, such as a corresponding avatar) that, when combined with the updates to the meter indicia, visually indicate to a player that the corresponding game enhancement was applied to the current bonus game outcome. In one example for a game enhancement related to applying special symbols, upgraded symbols, modifiers, and the like to the bonus symbol positions, the new game elements are animated to fly or otherwise originate from the enhancement meter and/or corresponding avatar and move towards the bonus symbol positions.

If the value of the meter indicia of a given enhancement meter reaches or passes the inactive threshold, then the corresponding enhancement meter is transitioned to an inactive state for the bonus game instance. The presentation assembly animates or visually updates the enhancement meter and/or other associated graphical game elements to transition to the inactive state. In some embodiments, transitioning the enhancement meter to an inactive state visually indicates to the player that the corresponding game enhancement is not available for the remainder of the bonus game instance. In other embodiments, the game enhancement may still be available with the enhancement meter in the inactive state, but the trigger conditions and/or events may be different. For example, the game enhancement for an active meter is automatically applied to the game outcomes selected at step 114, while the game enhancement may be available in other bonus game outcomes through one or more trigger symbols occupying the symbol positions.

At step 120, the game-logic circuitry is configured to determine whether or not the bonus game is complete. In at least some embodiments, the game-logic circuitry stores one or more variables for monitoring the duration of the bonus game instance. In one example, the variable is configured to indicate a number of remaining bonus game outcomes or a number of completed bonus game outcomes, where the outcome determination at step 120 includes comparing the count value of the outcome counter to one or more predefined threshold or termination values. If the current value has met or exceeded the predefined threshold value, the game-logic circuitry concludes the bonus game instance. In another example, the variable is configured to monitor a period of time or a number of other game events or conditions (including the absence of certain game elements in the bonus game outcomes). In certain embodiments, multiple termination conditions may be available for a bonus game instance. For example, the bonus game instance may have a static or dynamic game duration and include one or more game events that automatically conclude the instance when detected, such as every enhancement meter reaching an inactive state.

If, at step 120, the game-logic circuitry determines the bonus game instance has remaining duration, the method 100 returns to step 116 for a subsequent bonus game outcome. Steps 116-120 are repeated for each bonus game outcome of the bonus game instance until the game-logic circuitry determines at step 120 that the bonus game instance has reached a conclusion or termination condition. The method 100 then proceeds to step 122. More specifically, the game-logic circuitry causes the presentation assembly to animate a transition sequence to update the game interface from a bonus game interface to a base game interface to continue the base game. The transition sequence may include animations and/or visual elements configured to recap the bonus game instance (e.g., a cumulative award sequence for the awards collected from the bonus game instance) and/or present the game and presentation elements associated with the base game. It is to be understood that although the example embodiment transitions from the bonus game instance back to the base game, the bonus game instance may transition to a different game feature at step 122 based on the game configuration.

In the example embodiment, the transition sequence includes resetting the enhancement meters for play of the base game (i.e., accumulating meter value for the next bonus game instance). In some embodiments, the reset value is a predefined static value. In other embodiments, the reset value may vary based on one or more events, conditions, random determinations, and the like. In one example, the reset value is randomly selected from a range of available values. In another example, the reset value is based on events occurring in the bonus game instance, such as the number of certain symbols, winning symbol combinations, and the like from the bonus game outcomes. In a further example, the player is provided with an aggregate value, and the presentation assembly prompts the player to provide input to allocate the aggregate value between the enhancement meters to establish the reset values according to the preferences of the player. The reset value may be the same for every enhancement meter, or each enhancement meter may be independently reset. One example transition sequence may include, for example, each enhancement meter being reset initially to the same value before randomly adjusting the value of one or more meters to a different value prior to an initial base game outcome.

The method 100 continues for another cycle of the base game and subsequent bonus game instances until the gaming session is concluded. The gaming session is concluded in response to the credit balance (or other suitable balance associated with the gaming session for non-wagering embodiments) being unable to fund a subsequent wager or the player initiates a cashout sequence. In some embodiments, the game enhancements described with respect to the method 100 may be available within the base game. For example, certain update trigger events (e.g., two or more update trigger symbols in a base game outcome) and/or other suitable trigger events detectable within the base game causes the game-logic circuitry to apply the game enhancement of one or more enhancement meters automatically to the current or next base game outcome. In another example, if an update trigger event is detected for an enhancement meter that has already reached a maximum meter value, the game enhancement is applied to one or more base game outcomes. In such embodiments, the enhancement meters may be adjusted in response to the base game application of the enhancement, or the enhancement meter is unaffected by the base game application.

FIG. 4 depicts an example game interface 200 for a gaming system, such as the system shown in FIGS. 1 and 2. The interface 200 is a graphical interface presented by a presentation assembly of a gaming machine (e.g., the machine 10 shown in FIGS. 1 and 2) for play of a game at the gaming machine. The interface 200 includes a plurality of symbol positions arranged into a symbol array 202, a credit meter 204, a wager or bet meter 206, an award meter 208, and a set of enhancement elements 210. In other embodiments, the interface 200 includes mechanical presentation elements (e.g., mechanical reels) and/or includes additional, fewer, or alternative game and presentation elements, including those described elsewhere herein.

The symbol array 202 is configured to be selectively populated by symbols for game outcomes. That is, symbols are at least partially randomly selected. from one or more sets of available symbols by game-logic circuitry of the gaming system in communication with the presentation assembly. In some embodiments, the sets of available symbols are symbol-bearing reel strips that are animated by the presentation assembly to spin and stop such that one or more symbols of the reel strip occupy the one or more symbol positions associated with the reel strip. In one example, each symbol position is associated with a respective reel strip. In another example, each column of the symbol array 202 is associated with a respective reel strip. It is to be understood that the available symbols may also include ‘blanks’ in some embodiments, where the blanks represent an absence of a symbol in a given symbol position for a game outcome.

In at least some embodiments, the sets of available symbol positions, reel stop positions, and the like are stored in one or more weighted tables by the game-logic circuitry. Each weighted table includes a weight parameter linked to an available symbol, reel stop position, or other variable defining a game outcome, and the game-logic circuitry is configured to compare one or more random values or other random variables from the RNG unit to the weighted table to generate a game outcome. In one example, each symbol is stored within the game-logic circuitry with a weight parameter representing a subrange of a total range of possible values that can be generated by the RNG unit, where relatively larger subranges indicate a higher probability of selecting the corresponding symbol. A random value from the RNG unit is generated and compared to the weighted subranges, and the game-logic circuitry retrieves the symbol corresponding to the subrange including the random value for the game outcome.

The symbol array 202 includes a plurality of symbol positions arranged into rows and columns for presenting the selected symbols of a game outcome. The positional relationship of the symbol positions within the array 202 may be used to identify winning symbol combinations (e.g., via paylines) and/or other suitable game events or conditions. In the example embodiment, the symbol array 202 includes 25 symbol positions arranged to five rows and five columns. In other embodiments, the symbol array 202 includes a different number of symbol positions, rows, and/or columns. In certain embodiments, the game interface 200 may include a plurality of symbol arrays 202, where each array 202 is spaced apart from each other within the interface 200.

The meters 204, 206, 208 are presented within the interface 200 to provide players visual elements for monitoring particular game events or conditions. In particular, the credit meter 204 monitors the credit balance of the player, the bet meter 206 monitors the current or last wager made by the player, and the award meter 208 tracks one or more awards collected during the gaming session. For example, the award meter 208 monitors the last collected award, any awards from the current or last game outcome (including awards having a value of zero for nonwinning game outcomes), the cumulative award of a particular period of time, game feature, or the gaming session as a whole, and/or the like. In other embodiments, additional, fewer, or alternative meters may be included in the game interface 200. For example, one or more progressive jackpot meters may be presented in addition to the meters 204, 206, 208.

The enhancement elements 210 are presented above the symbol array 202. Each enhancement element is associated with one or more game enhancements to be applied to a game feature as described in detail herein. The enhancement elements 210 are visual representations of the game enhancement to facilitate animations and visual updates that indicate to the player certain game events and/or conditions associated with a game enhancement, such as the application of a game enhancement to a game outcome. The enhancement elements 210 and corresponding sub-elements are configured to be presented in a plurality of states representing different functionality relating to the game enhancement. In one example, the enhancement elements 210 include a base game or collection state for accumulating game enhancements, an active state in which the game enhancements are available to be applied to a game outcome, and an inactive state in which the game enhancement is not available until the state of the enhancement element 210 is changed.

In the example embodiment, each enhancement element 210 includes an enhancement avatar and an enhancement counter or meter. In some embodiments, the enhancement elements 210 include additional indica or other presentation elements, such as the indicia shown in FIG. 4 visually indicating the corresponding game enhancement for each enhancement element 210. In the illustrated embodiment, the interface 200 includes three enhancement elements 210. The first enhancement element 210 includes a first enhancement avatar 212 and a first enhancement counter 218, a second enhancement element 210 includes a second enhancement avatar 214 and a second enhancement counter 220, and a third enhancement element 210 includes a third enhancement avatar 216 and a third enhancement counter 222. The enhancement elements 210 may include additional, fewer, or alternative elements in other embodiments. The first enhancement element 210 is associated with a first game enhancement for extending the symbol array 202 (i.e., adding additional symbol positions). The second enhancement element 210 is associated with a second game enhancement for distributing wild symbols through the symbol array 202. The third enhancement element 210 is associated with a third game enhancement for applying a multiplier to one or more awards. Other suitable game enhancements may be used in other embodiments, including, but not limited to, free spin awards, enhanced pay tables, credit awards, symbol enhancements and/or conversions, jackpot awards, jackpot triggers, external awards (i.e., awards provided beyond the scope of the gaming session, such as player loyalty awards, food and beverage awards, and the like), and/or other suitable awards. The game enhancements do not necessarily guarantee an award to the player but may rather provide additional or enhanced opportunity to collect an or achieve another game event through play of the game.

The enhancement elements 210 are configured to facilitate animations and visual updates associated with the enhancement game functionality as described herein. For example, the enhancement avatars 212, 214, 216 are animated via the presentation assembly in response to game events associated with the game enhancements, such as the corresponding game enhancement being applied to a game outcome or the enhancement counters 218, 220, 222 being adjusted. The counters 218, 220, 222 are configured to monitor an enhancement value. In some embodiments, the enhancement value indicates a number of outcomes or applications that the corresponding game enhancement can be applied to as described herein. In other embodiments, the enhancement value may represent a different value associated with the game enhancement. In one example, the enhancement value is a balance of credits, wild symbols, and/or other suitable game elements that is at least partially distributed each time the game enhancement is applied. In the example embodiments, the counters 218, 220, 222 are configured to present values within a range defined by a termination value and a maximum enhancement value, which may be defined for the counters 218, 220, 222 collectively or independently. The termination value is a threshold value defining the boundary between active and inactive game enhancements, where reaching or exceeding the termination value causes an active game enhancement to transition to an inactive state. The maximum enhancement value is a value that the counters 218, 220, 222 cannot exceed. In at least some embodiments, the maximum enhancement value matches the duration of a bonus game instance, thereby indicating that the corresponding game enhancement is automatically applied to each bonus game outcome of the instance. In other embodiments, the maximum enhancement value is less than the full duration of a bonus game instance or the counters 218, 220, 222 are not limited to a maximum value.

In the example embodiment, game-logic circuitry of the gaming system is configured to conduct a game including a base game feature and a bonus game feature associated with the enhancement elements 210 and cause the presentation assembly to present animation sequences associated with the game via the game interface 200. More specifically, the base game includes base game outcomes with respective sets of randomly selected symbols. The base game outcomes may include collection trigger events that cause the enhancement counters 218, 220, 222 of any corresponding enhancement element 210 to increase towards the maximum enhancement value. In other words, the base game feature includes a value collection mechanism for the enhancement elements 210. In response to a bonus trigger event, the interface 200 is animated to transition to a bonus game state for play of a bonus game instance have a predefined duration representing a certain number of bonus game outcomes (e.g., five, eight, or ten outcomes). At least one of the enhancement elements 210 is active during the bonus game instance and carries the collected value from the corresponding counter 218, 220, 222 into the bonus game instance. The active enhancement elements 210 are selectively and randomly applied to the bonus game outcomes of the instance based on the counter values. After each application, the counters 218, 220, 222 are decremented or otherwise updated towards the termination value, which in this example is zero. When the counters 218, 220, 222 visually present indicia indicating a value of zero, the corresponding enhancement element 210 is transitioned to an inactive state for the bonus game instance. Following the game enhancement applications and completion of the bonus game duration, the bonus game instance concludes and transitions the interface 200 back to the base game state for the base game feature. In some embodiments, the counters 218, 220, 222, remain at the same value from the conclusion of the bonus game instance. In other embodiments, the counters 218, 220, 222 are updated to a reset value for the base game feature. In one example, the counters 218, 220, 222 are updated to a reset value of two such that even immediately after the transitioning back to the base game feature, at least one game enhancement is available for a subsequent bonus game instance.

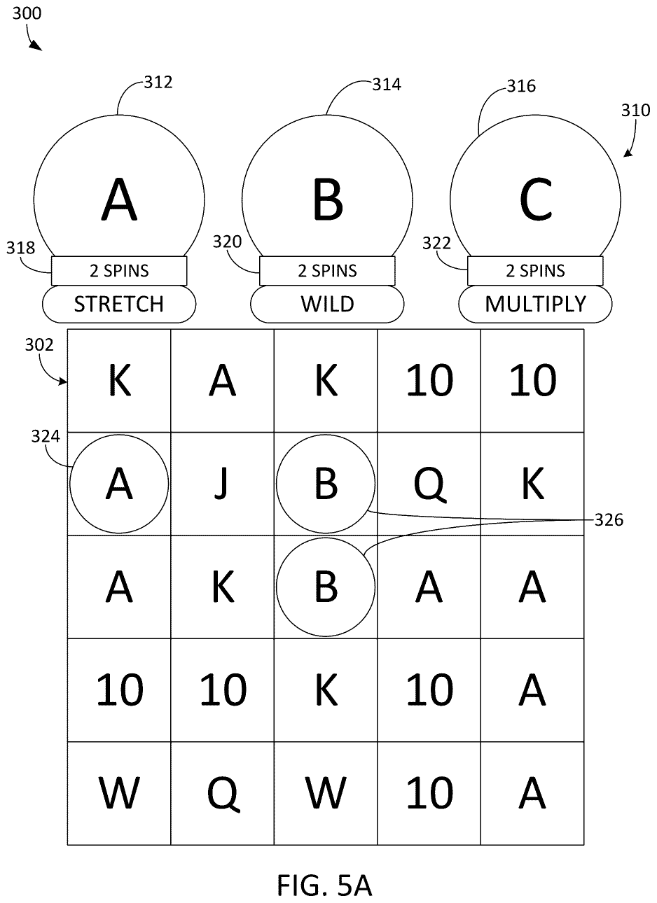

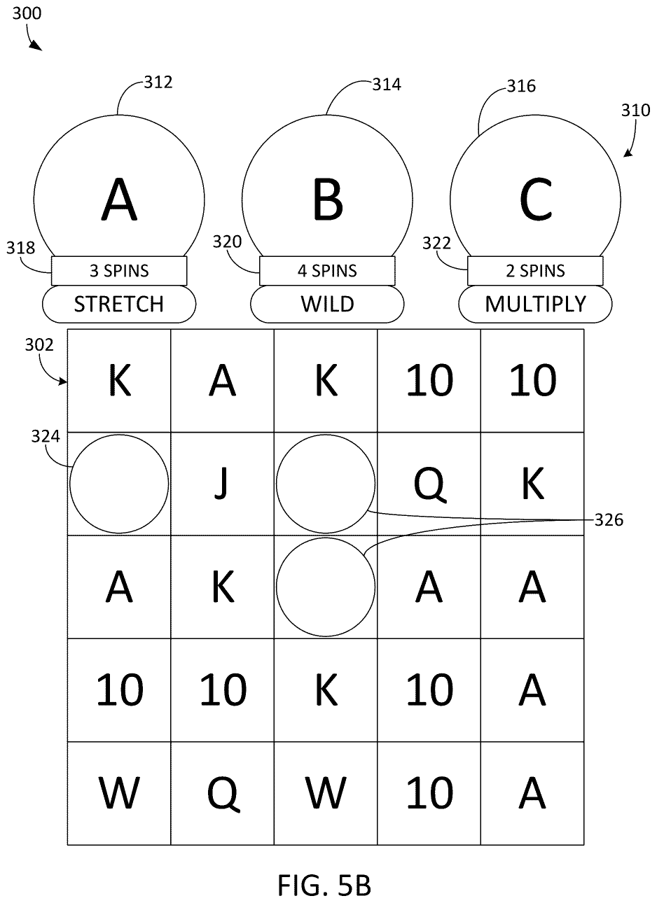

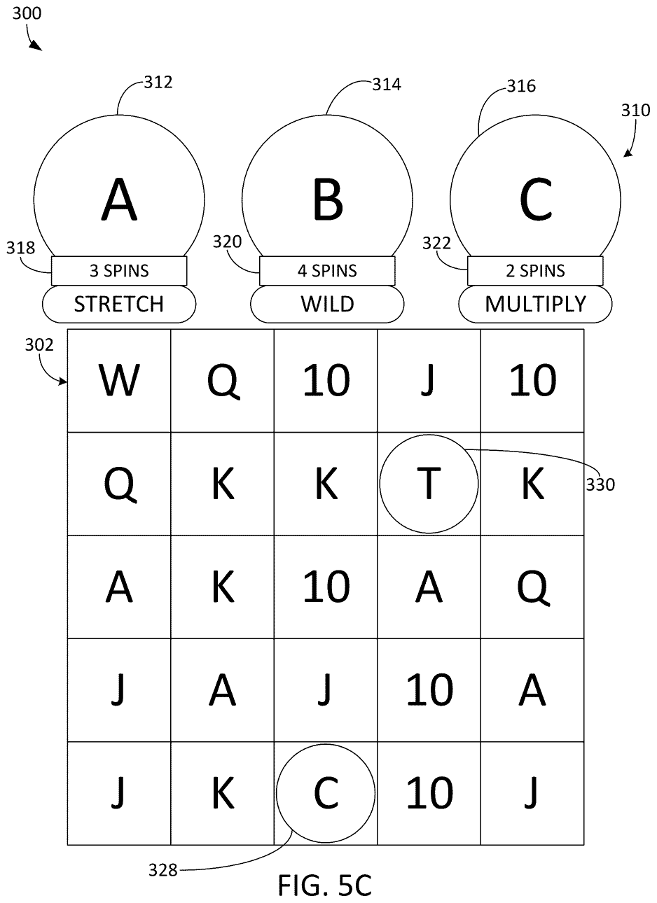

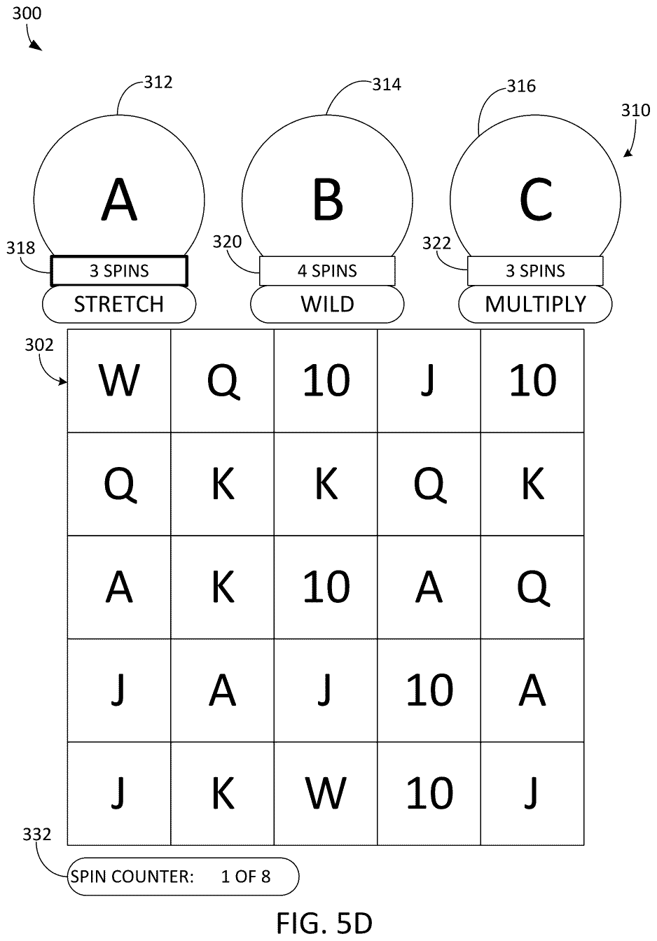

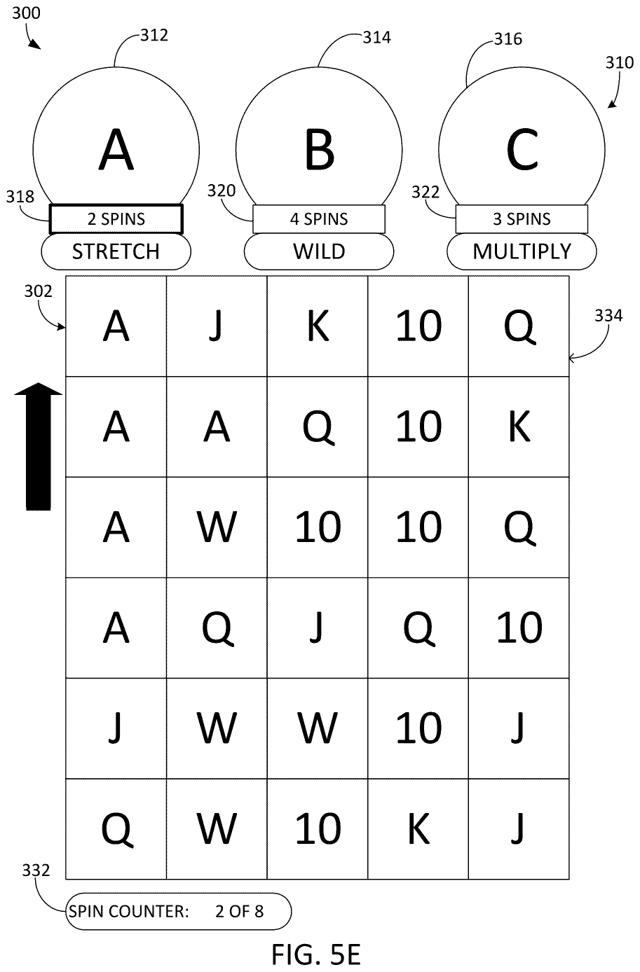

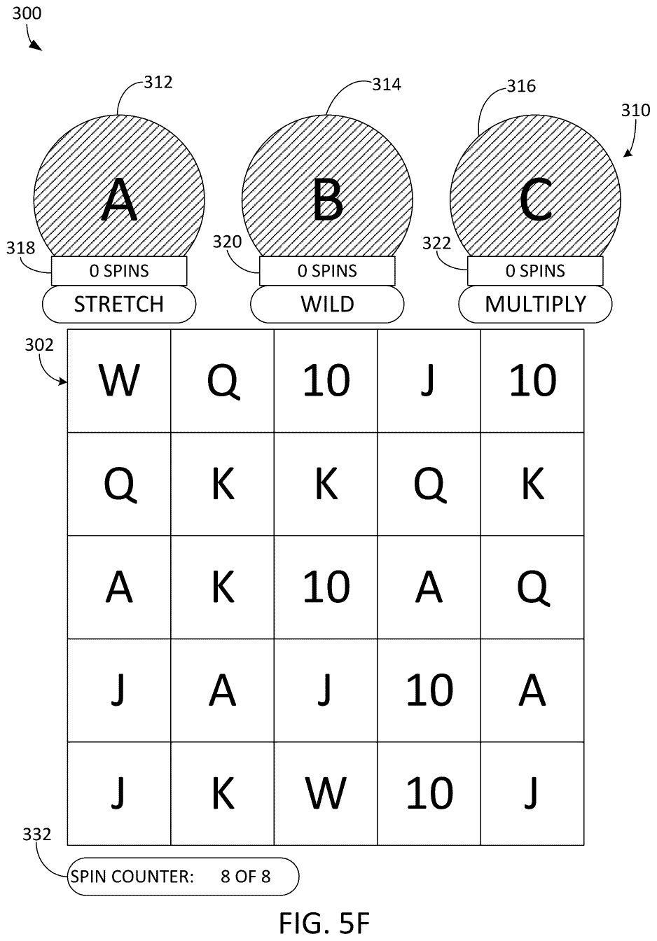

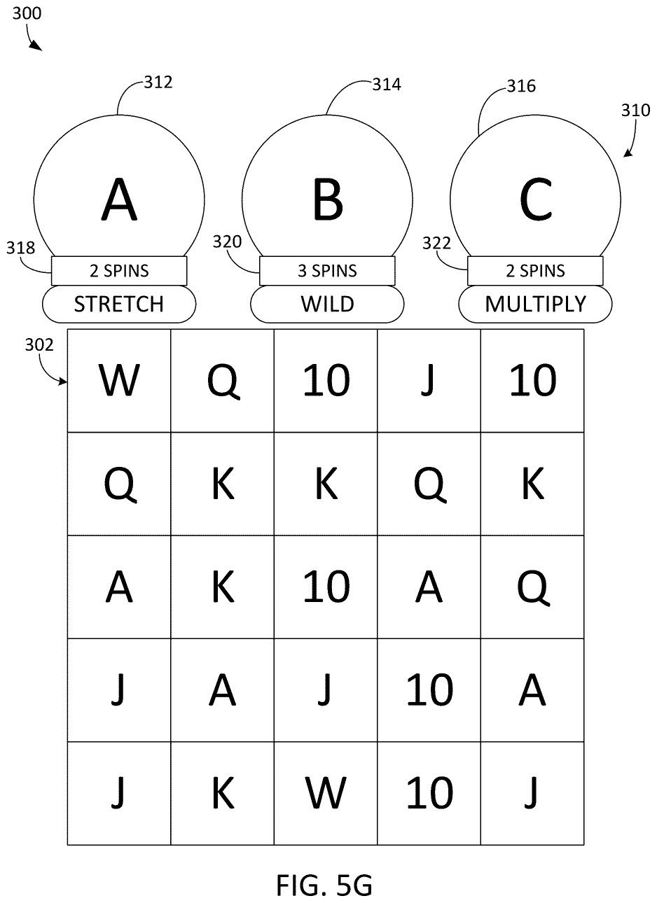

FIGS. 5A-5G depict a game interface 300 of a gaming system (e.g., the system shown in FIGS. 1 and 2) for presenting game animation sequences in various game states. The interface 300 is presented by a presentation assembly of a gaming machine that is in communication with game-logic circuitry of the gaming system to provide the functionality described herein. The interface 300 may be similar to the interface 200 shown in FIG. 4 unless otherwise noted. In other embodiments, the game interface 300 includes additional, fewer, or alternative game elements, presentation elements and/or animation sequences, including those described elsewhere herein.

FIG. 5A depicts the game interface 300 in a first state during a base game feature of a game conducted by the gaming system. In the first state, the game interface 300 includes a symbol array 302 and three enhancement elements 310. The enhancement elements 310 include a first enhancement element including a first enhancement avatar 312 and a first enhancement counter or meter 318, a second enhancement element including a second enhancement avatar 314 and a second enhancement meter 320, and a third enhancement element including a third enhancement avatar 316 and a third enhancement meter 322. The enhancement elements 310 are associated with game enhancements similar to the enhancements described with respect to the game enhancements of FIG. 4 as indicated by the same enhancement indicia between FIGS. 4 and 5A-5G.

The enhancement elements 310 are positioned adjacent to and above the symbol array 302. In other embodiments, the enhancement elements 310 may be presented in a different configuration relative to the array 302. The avatars 312, 314, 316 include visual characteristics that distinguish the enhancement elements 310 from each other and identify other game elements within the interface 300 that are linked to the corresponding enhancement element 310. In the example embodiment, each avatar 312, 314, 316 is visually distinguished by a letter (A, B, C) visually presented within the respective avatar.

In the first state, the interface 300 depicts a base game outcome. More specifically, the symbol array 302 is populated by randomly selected symbols from one or more sets of available symbols. The symbols are randomly selected by the game-logic circuitry based at least partially on one or more values generated by an RNG unit of the game-logic circuitry and weight parameters assigned to each available symbol, reel stop positions, and/or other selectable option according to the configuration of the base game. In response to generating the base game outcome, the game-logic circuitry performs one or more outcome determinations to identify any game events or conditions from the base game outcome. The outcome determinations include comparing one or more data elements representing the current state of the base game to predefined parameters or variables and performing any corresponding actions to the state of the game based on the comparison.

The game-logic circuitry further generates an animation sequence of the base game outcome for presentation by the presentation assembly. That is, based on the randomly selected symbols, the outcome determinations, and/or other suitable dynamic data structures and data determinations, graphical data stored by the game-logic circuitry is retrieved to generate a video data stream relative to the different game events and game states. For example, one or more symbol-bearing reel strips may be animated to spin and stop such that the randomly selected symbols are presented within the symbol positions of the symbol array 302. If a winning combination of symbols are detected, the game-logic circuitry may generate an award sequence that highlights the symbols of the winning combination such that the sequence is not merely retrieving stored graphical data, but rather includes compositing and/or generating graphical data according to the particular state of the game interface 300 (e.g., the position of the symbols relative to each other in the array 302). It is to be understood that the graphical functionality (or game functionality described in combination with graphical elements) described herein may include such graphical compositing and dynamic generation to form the game interface 300.

The base game outcome of the first state includes an update trigger event. The update trigger event causes one or more of the enhancement meters 318, 320, 322 to be updated. The update trigger event includes the presence of one or more update trigger symbols occupying the symbol array 302. More specifically, the base game outcome includes a first update trigger symbol 324 and two second update trigger symbols 326. The first update trigger symbol 324, as indicated by the shared indicia with the first enhancement avatar 312, is associated with the first enhancement element. The second update trigger symbols 326 are associated with the second enhancement element. In some embodiments, one or more update trigger symbols may be associated with a plurality of enhancement elements 310 (e.g., an update trigger symbol with “ALL” indicia). The example embodiment, the update trigger event is detected in response to at least one update trigger symbol occupying the symbol array 302. In other embodiments, a different threshold number of update trigger symbols, a particular combination of symbols, and/or other suitable game events are required to determine whether or not an update trigger event has occurred.

In some embodiments, one update trigger event is detected per update trigger symbol in the array 302 such that multiple update trigger symbols of the same type (e.g., the second update trigger symbols 326) are detected as independent update trigger events. In other embodiments, one update trigger event is triggerable on a per-element basis. That is, in the example embodiment, both the first and second enhancement elements are associated with a single respective update trigger event despite the different number of update trigger symbols 324, 326. In further embodiments, a single update trigger event is available per game outcome, and the game-logic circuitry includes a predefined set of instructions to determine which enhancement element(s) 310 are associated with the update trigger event. For example, the second update trigger event may be selected to be executed over the first update trigger event due to the second update trigger event including two update trigger symbols 326 in comparison to a single update trigger symbol 324.

In response to detecting the update trigger events, an update sequence is presented via the game interface 300. The update sequence includes visually updating the enhancement elements 310 associated with the update trigger events. More specifically, in the illustrated embodiment, the enhancement meters 318, 320 of the first and second enhancement elements, respectively, are updated based on the update trigger symbols 324, 326.

FIG. 5B depicts the game interface 300 in a second state following the first state. In the second state, the update sequence initiated in response to the first state has been (or currently is) presented by the presentation assembly. The second state includes changes to the enhancement meters 318, 320 and the update trigger symbols 324, 326 relative to the first state. The enhancement meters 318, 320 are incremented or otherwise updated based on the update trigger symbols 324, 326, thereby increasing the available game enhancements to be applied as described herein. In the example embodiment, each update trigger symbol causes the respective enhancement meters 318, 320 to be incremented. That is, the first enhancement meter 318 is updated from a meter value of two in the first state to a meter value of three in the second state based on the update trigger symbol 324. The second enhancement meter 320 is updated from a meter of two in the first state to a meter value of four in the second state based on the two update trigger symbols 326. In other embodiments, the number of update trigger symbols does not change the increment or other update to the meters 318, 320 (e.g., both meters 318, 320 are updated from two to three irrespective of the difference in update trigger symbols 324, 326). In other embodiments, additional or alternative conditions or events may affect the change to the meters 318, 320. In one example, the update trigger symbols 324, 326 include update indicia or other suitable visual characteristics that vary the updated meter values. In another example, one or more random values selected from a range of values are incorporated into the update sequence. In a further example, the increase to the meter value is at least partially based on bet or wager level.

The update sequence includes one or more animations to visually indicate to the player the underlying game events and corresponding actions. In the illustrated embodiment, the update trigger symbols 324, 326 are updated to visually remove the respective indicia to indicate to the player that the update trigger symbols 324, 326 have been applied to the meters 318, 320. In other embodiments, other suitable visual updates and animations may be used to convey the relationship between the update trigger events and enhancement elements 310 and the resulting updates to the meter values. For example, the update trigger symbols 324, 326 may be animated to move or ‘fly’ towards the corresponding enhancement avatars 312, 314 and/or enhancement meters 318, 320, the meters 318 are then visually updated, and the update trigger symbols 324, 326 are removed from the game interface 300.

In certain embodiments, the update trigger symbols 324, 326 include additional functionality for the base game feature. In one example, a threshold number of update trigger symbols (e.g., two symbols, like the update trigger symbols 326) beyond the threshold number for the update trigger event may cause the corresponding game enhancement(s) to be applied to one or more base game outcomes, such as the current base game outcome or the next base game outcome. Applying the game enhancement may affect the meter value of the corresponding enhancement meter, or the meter may remain unaffected by the base game application.

FIG. 5C depicts the game interface 300 in a third state following the second state. The third state includes a subsequent base game outcome. The subsequent base game outcome includes a new set of randomly selected symbols populating the symbol array 302. The randomly selected symbols include a third update trigger symbol 328 associated with the third enhancement element and a bonus trigger symbol 330. The third update trigger symbol 328, similar to the update trigger symbols 324, 326, is associated with an update trigger event for the third enhancement element. That is, in response to detecting the third update trigger symbol 328, the enhancement meter 322 is updated from a meter value of two to three as shown between FIGS. 5C and 5D. In some embodiments, one enhancement element 310 requires a different number of update trigger symbols relative to the other enhancement elements 310.

In certain embodiments, the game-logic circuitry is configured to receive player input to customize the update trigger event threshold for each element 310 and/or other configurable aspects of the game features described herein, such as the game enhancements associated with each of the enhancement elements 310. The player input may be received, for example, in response to the presentation assembly presenting (e.g., via the game interface 300) a prompt requesting the player input. The customization of the game features is available within regulatory and game design constraints. For example, in at least some regulatory jurisdictions, each possible player-customized game instance may have substantially the same payback percentage. The customization enables a player to adjust the game to his or her game preferences.

The bonus trigger symbol 330 is associated with one or more bonus trigger events available within the base game feature. The bonus trigger events cause the base game feature to transition to a bonus game feature having a limited game duration. Similar to the update trigger events above, the bonus trigger event is active in response to detecting a threshold number of bonus trigger symbols in the array 302. In the example embodiment, the bonus trigger event requires one bonus trigger symbol 330 to be active. In other embodiments, additional or alternative game events and/or conditions may be required to activate a bonus trigger event. In some examples, the threshold number of bonus trigger symbols is greater than one (e.g., three or six symbols). In one example, the bonus trigger event is based on bonus trigger symbols 330 accumulated over a plurality of base game outcomes. In another example, a certain wager level, wager frequency, or playtime may be required to activate the bonus trigger event. In a further example, additional symbols may be required to activate the bonus trigger event, such as at least one update trigger symbol 328 concurrently occupying the array 302 with the bonus trigger symbol 330.

In response to detecting a bonus trigger event, the game-logic circuitry causes the presentation assembly to animate a transition sequence for the game interface 300. More specifically, the game interface 300 is animated to transition from a base game state or configuration to a bonus game state for play of a bonus game instance. The bonus game instance is a limited duration game instance associated with the bonus game feature. The base and bonus game features may include different game or presentation elements within the interface 300 to facilitate different game functionality and game presentations, and the transition sequence is configured to remove or update the graphical elements of the base game interface 300 (shown in FIGS. 5A-5C) and add new graphical elements for the bonus game interface 300 (shown in FIG. 5D). The particular animations to update the state of the game interface 300 are configurable to match the particular game and presentation configuration provided by the gaming system.

In the example embodiment, the game-logic circuitry is configured to update the third enhancement element in response to the update trigger symbol 328 prior to or during the transition sequence. In other embodiments, the update trigger event may be ignored if a concurrent bonus trigger event is detected. In certain embodiments, update trigger events occurring simultaneously with a bonus trigger event may cause one or more changes to the initial state of the bonus game instance. In one example, rather than updating the enhancement meter 322, the update trigger symbol 328 causes the corresponding game enhancement to be automatically applied to the first bonus game outcome of the bonus game instance.

In the example embodiment, the enhancement elements 310 are associated with one or more bonus game functions as described herein. The meter values of the enhancement meters 318, 320, 322 are carried into the bonus game instance. In some embodiments, the meter values may be enhanced or otherwise changed through the transition sequence. In one example, the meter values are incremented through the transition sequence. In another example, the bonus game instance is initiated with one or more distributed values that are randomly applied to the meters 318, 320, 322. All three elements 310 are in an active state at the initial state of the bonus game feature. That is, all three meters 318, 320, 322 have a nonzero value, thereby indicating the corresponding game enhancement is available to be applied to subsequent bonus game outcomes. In other embodiments, the bonus game instance may be initiated with none or a subset of the enhancement elements 310 in the active state. In such embodiments, the state of each element 310 may be determined by the bonus trigger event, random selection, player input, historical gameplay data (e.g., wager level, wager frequency, playtime, etc.). In one example, the update trigger symbols present in the base game outcome including the bonus trigger event result in the corresponding enhancement element 310 being active in the bonus game instance.

FIG. 5D depicts the game interface 300 in a fourth state following the third state. In the fourth state, the transition sequence has completed, and a bonus game outcome is being presented. In the illustrated embodiment, the game interface 300 in the bonus game instance shares several presentation elements with the base game feature. More specifically, the symbol array 302 and the enhancement elements 310 are presented in the bonus game instance. In some embodiments, the array 302 and/or the elements 310 include different visual characteristics and/or animations to visually distinguish the bonus game feature from the base game feature. The array 302 may include additional or fewer symbol positions or arrange the symbol positions in a different configuration relative to the base game array 302. The avatars 312, 314, 316 of the enhancement elements 310 may be animated according to a different set of graphical data stored for the bonus game feature.

In addition to the graphical elements from the base game feature, the game interface 300 in the fourth state includes a spin or outcome counter 332. The spin counter 332 is presented to enable the player to visually monitor the remaining duration of the bonus game instance. In the illustrated embodiment, the counter 332 indicates that the bonus game instance has a predefined duration of eight spins, and the current spin or outcome is the first bonus game outcome. In response to each bonus game outcome, the counter 332 is updated towards a termination value (e.g., eight), where reaching the termination value indicates the bonus game instance is concluded. In other embodiments, the counter 332 may express the remaining duration through other suitable indicia and/or graphical elements. In one example, instead of incrementing, the counter 332 decrements towards a termination value of zero. In another example, a plurality of graphical elements (e.g., lights) sequentially transition from an active state to an inactive state for each bonus game outcome to visually indicate the remaining duration.

In the example embodiment, the duration of the bonus game instance is predefined and remains static through the bonus game instance. In other embodiments, the bonus game instance has a dynamic duration that is selectively extended or reduced in response to game events or conditions detected during play of the bonus game instance. In one example, a particular symbol or combination of symbols may extend the duration of the bonus game instance. In another example, the bonus game instance may be concluded when all meters 318, 320, 322 have expired and the corresponding enhancement elements 310 are all inactive.

In the fourth state, none of the game enhancements from the enhancement elements 310 have been applied to the bonus game outcome. In the example embodiment, the meter values indicate the number of bonus game outcomes in which the corresponding game enhancements are applied. That is, of the eight spin duration of the bonus game instance, the game enhancements of the first and third enhancement elements 310 are selectively applied to three bonus game outcomes, and the game enhancement of the second enhancement element 310 is selective applied to four bonus game outcomes as indicated by the meters 318, 320, 322 following the transition sequence. In other embodiments, the meter values are not guaranteed to be exhausted within a bonus game instance such that meter values may be nonzero values at the conclusion of the bonus game instance.

Rather than automatically applying the game enhancements to from the first bonus game outcome to the next bonus game outcome until the meter value is zero, the game enhancements are applied in response to a random selection process conducted by the game-logic circuitry. That is, the game-logic circuitry selects which bonus game outcomes that the respective game enhancements are applied to based at least in part on the meter values and one or more random determinations (e.g., random values generated by the RNG unit of the game-logic circuitry). The game enhancements are applied independently of each other such that a single bonus game outcome may include multiple game enhancements, one game enhancement, or no game enhancements. In some embodiments, the game-logic circuitry selects which bonus game outcomes include game enhancements in response to the bonus game instance initiating such that the selection is complete prior to the bonus game outcomes being presented. In other embodiments, the game-logic circuitry is configured to select game enhancements on a per-outcome basis, where the game-logic circuitry selects game enhancements between each bonus game outcome being generated and presented. In certain embodiments, the selection is performed in two stages: a first stage determining how many game enhancements are to be applied to a given bonus game outcome, and a second stage determining which game enhancement to apply based on the number of game enhancements to be applied. The random selection of game enhancements may be based on stored weight parameters that adjust the random distribution of outcomes to favor one selection relative to another selection.

In the example embodiment, the first game enhancement associated with the enhancement meter 318 is selected to be applied to a subsequent bonus game outcome. The impending application is illustrated as a highlighted or bold border around the meter 318. It is to be understood that the application may be visually indicated by additional or alternative visual characteristics and/or animations. For example, when the corresponding game enhancement is to be applied to a bonus game outcome, the enhancement avatar 312 may be animated according to stored graphical data to visually indicate a game event is occurring in relation to the avatar 312.

FIG. 5E depicts the game interface in a fifth state following the fourth state. In the fifth state, the first game enhancement associated with the first enhancement meter 318 is applied to the game interface 300 for a bonus game outcome subsequent to the outcome shown in FIG. 5D. More specifically, the game enhancement is configured to extend the symbol array 302 by adding one or more symbol positions for the bonus game outcome. Adding new symbol positions creates new opportunities to land additional symbols that, when considered alone or in combination with other symbols, may increase the probability of collecting an award or trigger another game event. In the illustrated embodiment, the game enhancement adds an additional row 334 of positions to the array 302. In some embodiments, the expansion from the game enhancement is predefined. In other embodiments, the array expansion is variable, where the game-logic circuitry randomly determines the expansion to be applied to the symbol array 302. Similarly, although not shown in FIGS. 5A-5G, the wilds and multiplier enhancements of the second and third game enhancement elements, respectively, may be predefined or dynamic based on one or more determinations by the game-logic circuitry. Moreover, the functions and configurations described herein with respect to the array expansion game enhancement are applicable to other suitable game enhancements, including the enhancements of the second and third enhancement elements and other game enhancements described herein.

Between the fourth and fifth states of the game interface 300, the presentation assembly is configured to present an enhancement sequence to apply the enhancement to the current game state. For example, the symbol array 302 is animated to expand or otherwise gain the new row 334 within the enhancement sequence. The enhancement sequence may occur before, during, and/or following an outcome sequence for the bonus game outcome including the game enhancement. In one example, the array expansion is presented prior to the outcome sequence such that the expanded array 302 includes the new row 334 in the outcome sequence. In another example in which the spinning animation of the outcome sequence may begin prior to the enhancement sequence, the enhancement sequence causes the array 302 to expand prior to the reel-spinning animation of the outcome sequence stopping, thereby including the new row in the spinning and stopping animations. In a further example, the symbol array 302 is animated to spin and stop prior to the enhancement sequence, and the enhancement sequence includes spinning and stopping the new row 334 to add the additional symbols to the stopped symbols in the array 302.

In response to the outcome sequence of the bonus game outcome, the enhancement meter 318 associated with the applied game enhancement is decremented from a meter value of three to two, and the spin counter 332 is incremented towards a termination value. Prior to or during the outcome sequence of the bonus game outcome following the fifth state, the game enhancement is removed from the game interface. For example, the new row 334 is removed from the array 302 prior to the next bonus game outcome being presented. In another example, the wild symbols applied to the array 302 are removed with the other symbols to be replaced by a new set of randomly selected symbols. In certain embodiments, if a game enhancement is applied to consecutive bonus game outcomes, the game enhancement remains within the interface 300 or the game enhancement may be improved in subsequent outcomes. For example, if the subsequent game outcome includes the array expansion game enhancement, the array 302 may be further expanded (e.g., with a new row of symbol positions above the row 334).

The bonus game instance is configured to continue with bonus game outcomes while updating the enhancement meters 318, 320, 322 and the spin counter 332 as described above. When an enhancement meter 318, 320, 322 has reached an inactive threshold value (e.g., zero), the corresponding enhancement element is transitioned from an active state to an inactive state. In the inactive state, the enhancement element visually indicates that the corresponding game enhancement is not available for the remainder of the bonus game enhancement. In contrast, in the active state, the enhancement elements visually indicate that the corresponding game enhancement is available at least one more bonus game outcome based on the random selection by the game-logic circuitry. The inactive state may be reflected by changes to visual characteristics of the enhancement element and/or animations specific to the inactive state. In the illustrated embodiment, the active and inactive state are visually distinguishable based on shading applied to the enhancement avatars 312, 314, 316 (see, e.g., the visual difference between the active and inactive avatars 312, 314, 316 in FIGS. 5E and 5F, respectively). In other embodiments, the state of each enhancement element may be visually depicted through other suitable changes, including removal of the inactive enhancement elements 310 from the interface 300. In certain embodiments, the active and inactive states are distinguished simply through the meter values. That is, the active and inactive states appear substantially the same, but are distinguished by the active state having a nonzero meter value and the inactive state having a meter value of zero.

In some embodiments, an enhancement element remains inactive for the remainder of a bonus game instance. In other embodiments, the inactive enhancement elements may be selectively reactivated in response to a reactivation game event occurring in the bonus game instance. For example, the update trigger symbols may be available in the bonus game feature to extend the meter value of active enhancement elements and reactivate previously inactive enhancement elements in response to detecting the update trigger symbols in the array 302. In other embodiments, other suitable game events, including events based on other types of symbols or combinations of symbols, may be used to extend the meter values and/or reactivate enhancement elements.

FIG. 5F depicts the game interface 300 in a sixth state following the fifth state. In the sixth state, the duration of the bonus game instance has been completed as indicated by the spin counter 332, and the game enhancements have been applied to the bonus game outcomes until the respective enhancement meters 318, 320, 322 have reached the respective inactive thresholds, thereby causing the enhancement elements 310 to transition to the inactive state as indicated by the shading of the enhancement avatars 312, 314, 316. Each of the enhancement elements 310 are independently set to the inactive state based on the value of each meter 318, 320, 322 through the bonus game outcomes. The duration of the bonus game instance is unaffected by the state of the enhancement elements 310. For example, out of eight bonus game outcomes, even if every enhancement element 310 is in the inactive state by the fifth bonus game outcome, the bonus game instance continues to complete the remaining bonus game outcomes.

In other embodiments, the bonus game instance may automatically conclude in response to every enhancement element 310 reaching the inactive state. In one or more embodiments, the bonus game instance is initiated with a dynamic duration based at least partially on the meter values of the enhancement meters 318, 320, 322. In certain embodiments, the game-logic circuitry is configured to perform the game enhancement selection for a bonus game instance on a partially random basis. That is, the game-logic circuitry may store rules or parameters that, during the selection process, overrides a fully random selection. In one example, the final bonus game outcome may be guaranteed to include at least one game enhancement, thereby ensuring at least one enhancement element 310 is active throughout the bonus game instance. In another example, if the meter value for a given enhancement element 310 matches the duration of the bonus game instance (or includes another suitable maximum value), the corresponding game enhancement may be applied automatically to every bonus game outcome of the bonus game instance.

FIG. 5G depicts the game interface 300 in a seventh state following the sixth state. In the seventh state, the bonus game instance of FIGS. 5D-5F has concluded, and the presentation assembly is configured to animate the game interface 300 to transition from a bonus game state to a base game state for subsequent play of the base game feature. In some embodiments, rather than return to the base game feature, the game transitions from the bonus game instance to another suitable game feature, and the game interface 300 is updated accordingly.

The transition to the base game state includes removing the spin counter 332 (shown in FIG. 5F) from the interface 300 and resetting the meter values of the enhancement elements 310. That is, the meter values are set to nonzero values to ensure that each enhancement element 310 and corresponding game enhancement are available for a subsequent bonus game instance, even if the first base game outcome includes a bonus trigger event. The reset value may be a predefined value, a value randomly selected from a range of available values (e.g., initial meter value is randomly selected from a range of one, two, and three), and/or a dynamic value based on the game events and conditions in the prior bonus game instance. In other embodiments, the value of the meters 318, 320, 322 are not reset following the bonus game instance. For example, the bonus game instance may be concluded with one or more enhancement meters 318, 320, 322 including a nonzero meter, and the nonzero meter value is carried into the base game feature or the nonzero meter value is compared to a predefined reset value by the game-logic circuitry, where the greater value is stored and visually presented for the corresponding element 310.

The enhancement meters 318, 320, 322 may be set to a reset value collectively or independently, such as in the illustrated embodiment. More specifically, the first and third enhancement meters 318, 322 are set to a reset value of two, while the second enhancement meter 320 is set to a reset value of three. In certain embodiments, the player may be provided with a set of available reset values to manually assign between the available enhancement meters 318, 320, 322. In some embodiments, the game associated with the interface 300 includes additional enhancement elements 310 or additional game enhancements that can replace existing elements 310 or enhancements or be added to the interface 300. The replacement of existing elements 310 may be automatic (e.g., based on random determinations of the game-logic circuitry, predefined enhancement swapping following a bonus game instance, etc.) or manual, where the player may customize his or her gaming experience by selecting which enhancement elements 310 and game enhancements are active. The changes to the enhancement elements 310 or the game enhancements are reflected through animations and visual changes to the interface 300. In one example, the player may wish to change the multiplier game enhancement of the third enhancement element 310 to a different enhancement, such as a free spins enhancement that adds additional spins to bonus game instances. The player provides input (via the game interface 300 or one or more input devices of the gaming machine associated with the interface 300) selecting the new enhancement from a list of available game enhancements, and the changes are reflected by the indicia of the third enhancement element 310 updating within the interface 300 (e.g., from “MULTIPLY” to “FREE SPINS”). For additional enhancement elements 310 to be added to the interface 300, the player may be required to meet certain requirements, such as a wager level, wager frequency, credit balance threshold, player account history, gaming session playtime, achieving certain gameplay events or conditions, and/or the like.

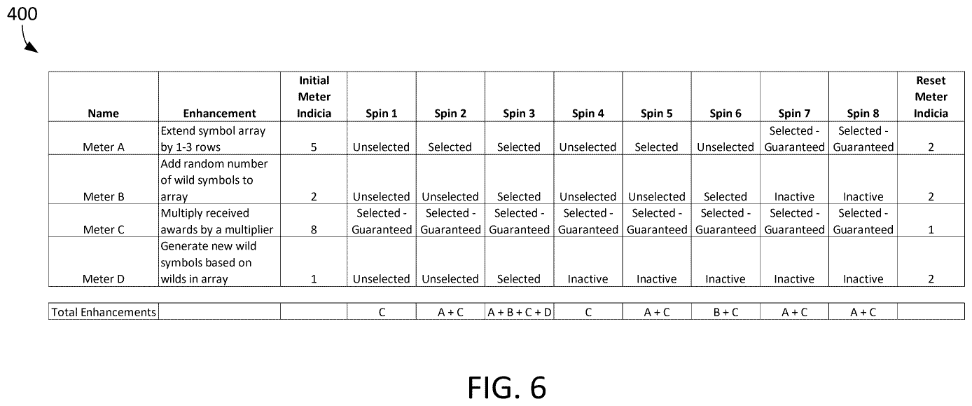

FIG. 6 depicts a table 400 depicts an example bonus game sequence of a gaming system (e.g., the system shown in FIGS. 1 and 2) according to one or more aspects of the present disclosure. The table includes four enhancement meters (Meters A, B, C, D) with corresponding game enhancements. The bonus game sequence corresponds to a bonus game instance that includes a predefined number of bonus game outcomes (i.e., eight spins). The meters of the table 400 have initial meter values at the beginning of the bonus game instance. The meter values are visually presented as indicia via a game interface (e.g., the interface 300, shown in FIGS. 5A-5G). In the example embodiment, the meter values are accumulated through game events occurring in a base game feature associated with the bonus game instance, and the meter values indicate a number of bonus game outcomes that will include the corresponding game enhancement within the bonus game instance. For example, Meter A has an initial meter value of five such that five of the eight bonus game outcomes include an array expansion game enhancement associated with the Meter A. Each of the meters have a nonzero initial value, and therefore every meter is in an active state. In some embodiments, one or more meters may begin the bonus game instance with a meter value of zero, thereby initiating the meter in an inactive state.

Game-logic circuitry of the gaming system is configured to selectively apply the game enhancements associated with each meter based at least in part on the meter values and one or more random variables (e.g., random numbers generated by an RNG unit of the game-logic circuitry). In the example embodiment, the selection occurs independently for each game outcome. That is, for each meter and corresponding game enhancement, a random determination is performed for each bonus game outcome to determine whether or not game enhancement is applied. Accordingly, if the meter value matches the remaining duration of the bonus game instance, the corresponding game enhancement is guaranteed to be selected and applied to the remaining bonus game outcomes. For example, Meter C has an initial meter value matching the total duration of the bonus game instance, and therefore the game enhancement of Meter C is automatically applied to each and every bonus game outcome of the instance. Similarly, by Spin or Outcome 7, Meter A has a meter value of two as described herein, and, with the remaining bonus game duration being two, the corresponding game enhancement is automatically selected for Spins 7 and 8.

The table 400 indicates a different status for each meter and game enhancement relative to each bonus game outcome or spin. For example, “Selected” indicates that the game enhancement has been selected and applied to the bonus game outcome, and “Unselected” indicates that the game enhancement is not applied to the outcome. As set forth above, “Selected —Guaranteed” indicates that the irrespective of any underlying random determination, the game enhancement is applied to the bonus game outcome. All three of these statuses (“Selected,” “Unselected,” and “Selected—Guaranteed”) indicate that the corresponding meter is in an active state. On a corresponding game interface, the visual characteristics of a meter in the active state visually indicate to the player that the corresponding game enhancement is still available for the current and next bonus game outcome. In contrast the “Inactive” status indicates that the meter has a value of zero (or other suitable inactive threshold value) and is in the inactive state. The inactive state is visually distinguishable from the active state to enable a player to readily identify that the corresponding game enhancement is no longer available until the meter returns to the active state.

In other embodiments, the game-logic circuitry is configured to select which game enhancements to apply to the duration of the bonus game instance as whole, particularly for bonus game instances having a predefined duration. That is, rather than determining which game enhancements to apply between generating each bonus game outcome, the game-logic circuitry randomly selects one or more bonus game outcomes to include a given game enhancement based on the initial meter value. Predetermining the game enhancement selections reduces the number of RNG calls required to define which outcomes include a particular enhancement, thereby reducing the computing burden on game-logic circuitry to provide the game functionality. For example, for a game enhancement associated with an initial meter value of five, the predetermined embodiments include the game-logic circuitry generating five random values from a range of one to eight (representing the game outcomes) instead of initiating up to eight RNG calls between game outcomes.

In contrast, determining game enhancements between each bonus game outcome facilitates dynamic play of the bonus game instance. That is, game events, game conditions, player input, and/or other suitable variable parameters alter or manipulate the current state of the bonus game instance to provide gameplay variety within regulatory specifications. For example, inactive meters may be reactivated within the bonus game instance and the corresponding game enhancement is selectively applied to subsequent game outcomes within the same set of computer-readable instructions defining the enhancement selection between outcomes without requiring a new set of executable instructions just for the reactivated meter in embodiments in which the selections are predetermined.

Table 400 indicates the different game enhancements applied to each spin or outcome (i.e., the “Total Enhancements” row indicates which, based on meter name, enhancement is applied to a given spin). Meter C has the maximum meter value, so the corresponding game enhancement is applied to every spin. The other meters are applied to a subset of the bonus game duration, and Spin 3 includes all of the enhancements from the meters. The game enhancements may be applied irrespective of any other applied enhancements for a given spin. In some embodiments, the game enhancements may influence or affect other game enhancements, and the game-logic circuitry stores a hierarchical order of operations to apply multiple game enhancements to a single spin. For example, the symbol array may be expanded prior to adding wild symbols to the array, thereby providing additional positions to be occupied by wild symbols.

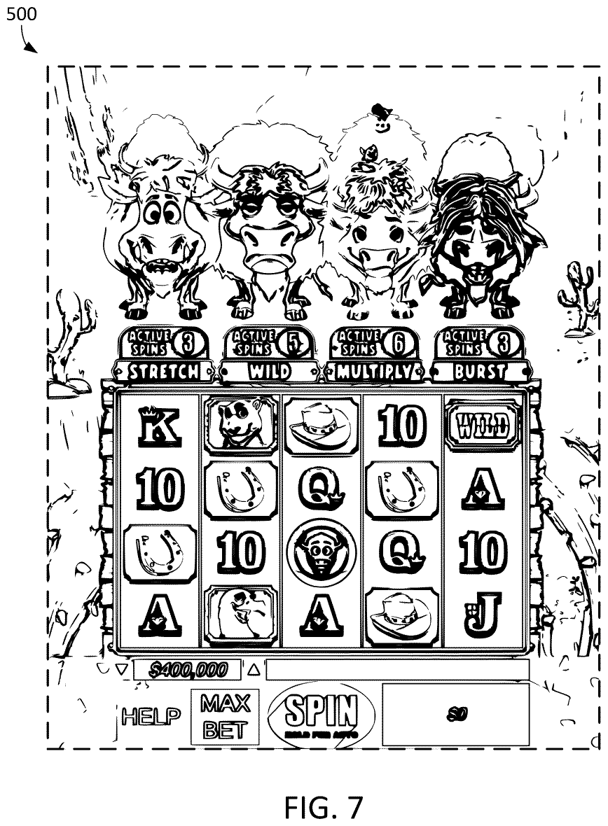

FIG. 7 depicts an example game interface 500 of a gaming system according to one or more aspects of the present disclosure. The interface 500 includes thematic graphical elements that facilitate the game functionality described herein. The interface 500 includes four buffaloes representing different game enhancements, where the game enhancements are visually indicated below the respective meters for each buffalo. The pixel arrangement of the buffaloes and meters is configured to visually indicate the relationship between each buffalo and each meter. Collectively, each buffalo and meter combination represents an enhancement element according to the present disclosure. The buffalo are animated via a presentation assembly of the gaming system to visually indicate certain game events, and the meters are updated as different trigger events are detected within play of the game feature.

Although the embodiments described above include a base game feature for collecting or accumulating meter values and a bonus game feature that applies game enhancements based on the meter value from the base game feature, it is to be understood that such game functionality may be reversed or otherwise adapted to work within other game configurations. In one example, the game enhancements are applied based on meter values in the base game feature with accumulation occurring in both the base and bonus game features. In such an embodiment, the collection during the bonus game feature may be enhanced to include additional or alternative value to the meter relative to the collection functionality in the base game feature. In another example, the collection and application of game enhancements based on a meter value may occur in both the base and bonus game features, or the underlying game may include a single game feature.

The embodiments disclosed herein refer to various visual updates to graphical (or partially graphical) game interfaces, including animations, animation sequences, and the like. Such visual updates are performed through the game-logic circuitry retrieving stored graphical game assets and generating cohesive graphical game interfaces through the combination of the current game state and the retrieved game assets into video data for the presentation assembly. The video data is provided to the presentation assembly in a data structure recognized by the presentation assembly to convert the video data into visible outputs via physical components, such as light-emitting diodes (LEDs) arranged into a pixel matrix. Changes to the game interface include a comparison of data structures representing the current state of the game to data structures representing a prior state and adjusting the corresponding graphical assets and resulting video to match the new game state to facilitate smooth transitions via the visible output of the presentation assembly. Animations may be stored as distinct, bespoke game assets and/or stored in an adaptable manner in which the animations are tailored to match the corresponding presentation and game assets. That is, if a game animation for an example game event is based on three symbols in a symbol array, the game-logic circuitry adapts the presentation of the animation based on the pixel locations of the three symbols within the interface such that the player can readily identify which symbols correspond to the game event depicted by the animation without storing a unique animation for every possible permutation of the game event. Accordingly, the animations and visual updates described herein are to be understood to include at least some pixel-level adaptation of the game state to the physical and/or addressable mediums on which the interfaces are ultimately presented (e.g., electronic display devices of a presentation assembly).

The embodiments of the present disclosure provide an innovative procedure for accumulating game enhancements in one game feature to be applied to another game feature. Game-logic circuitry presents graphical game elements including visual indicia for readily monitoring the accumulation and application of game enhancements. The systems and methods described above provide a technical solution relative to conventional-reel spinning games, where game functionality is dependent upon graphical symbols appearing in a symbol array. While these graphical symbols provide excitement and immersion into the game, the conventional symbol-based games rely upon overlapping combinations of symbols to denote different game events, thereby relying upon player memory or intuition to discern and monitor game events and/or additional interfaces or presentation elements to link the abstracted graphical symbols to the underlying game. In contrast, the systems and methods of the present disclosure provide clear, graphical presentation of new and unique game functionality through graphical meters that visually indicate different game events through indicia and different presentation states, including presentation states that include animating linked symbols from the symbol array to interact with the meters.

The present disclosure addresses the technical problems outlined above by providing a gaming system with an improved graphical game interface and associated graphical animation methods. The system utilizes a presentation assembly to display a graphical game interface featuring a plurality of symbol positions and a plurality of distinct graphical enhancement meters. Each enhancement meter is visually associated with a specific game enhancement and includes clearly readable meter indicia that visually indicate a current accumulated value (e.g., a number of enhancement applications). During base game outcomes, the game-logic circuitry directs the presentation assembly to animate the populating of symbol positions and, in response to specific update trigger events linked to the enhancement meters, to animate visual updates to the corresponding meter indicia, providing clear visual feedback of accumulated progress.

Upon detecting a bonus trigger event, the system causes the presentation assembly to animate a visual transition of the graphical game interface to a bonus game state, carrying over the visual state of any active enhancement meters. Within the bonus game, for each bonus game outcome where a game enhancement is to be applied (based on the accumulated value shown on its meter), the presentation assembly is directed to (i) present a distinct outcome sequence including specific animations visually associated with the applied game enhancement(s), and (ii) animate a visual update to the respective meter indicia (e.g., decrementing the displayed value) to clearly show the consumption of the enhancement. This provides an intuitive graphical link between the accumulated value and its effect. Upon completion of the bonus game, the presentation assembly animates a transition of the graphical game interface back to a base game state, which includes animating a visual update of the meter indicia on the enhancement meters to reflect their reset state, which may include a visually apparent random boost, thereby clearly conveying the new baseline for subsequent accumulation. This specific sequence of graphical presentations and animations provides a more comprehensible and engaging player experience by making the mechanics of the variable bonus enhancement feature explicit through the user interface.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a presentation assembly configured to present a graphical game interface including a plurality of symbol positions and a plurality of enhancement meters, wherein each meter of the plurality of enhancement meters is associated with a respective update trigger event type and a respective game enhancement and includes meter indicia visually indicating a current meter value; and
game-logic circuitry in communication with the presentation assembly, the game-logic circuitry configured to:
cause the presentation assembly to present one or more base game outcomes by populating, via animation of the graphical game interface, the plurality of symbol positions with randomly selected symbols;
in response to one or more update trigger events occurring within the one or more base game outcomes, cause the presentation assembly to visually update, for each of the one or more update trigger events, the meter indicia of the enhancement meter of the plurality of enhancement meters that is associated with the update trigger event;
in response to a bonus trigger event occurring within the one or more base game outcomes, cause the presentation assembly to visually transition the graphical game interface to a bonus game state for a bonus game instance including a plurality of bonus game outcomes, the bonus game instance including any active enhancement meter of the plurality of enhancement meters;
for each active enhancement meter, randomly select at least one bonus game outcome of the plurality of bonus game outcomes to apply the corresponding game enhancement at least partially as a function of the meter indicia of the active enhancement meter and one or more random values generated by a continuously-cycling random number generator of the game-logic circuitry; and
for each bonus game outcome associated with one or more active enhancement meters based on the random selection, cause the presentation assembly to (i) present an outcome sequence including animations associated with the game enhancements of the one or more active enhancement meters, and (ii) visually update the respective meter indicia of the one or more active enhancements in response to the outcome sequence.

2. The gaming machine of claim 1, wherein the active enhancement meters include any enhancement meter of the plurality of enhancement meters having a nonzero current meter value.

3. The gaming machine of claim 1, wherein the plurality of enhancement meters are updateable up to a maximum meter value.

4. The gaming machine of claim 3, wherein the game enhancement of a first active enhancement meter having a current meter value equal to the maximum meter value is automatically applied to every bonus game outcome of the plurality of bonus game outcomes.

5. The gaming machine of claim 3, wherein the maximum meter value is equal to a total amount of outcomes within the plurality of bonus game outcomes.

6. The gaming machine of claim 1, wherein bonus trigger events include detecting one or more bonus trigger symbols within the one or more base game outcomes, and wherein each enhancement meter of the plurality of enhancement meters is associated with a respective bonus trigger symbol type.

7. The gaming machine of claim 1, wherein the logic circuitry is further configured to cause the presentation assembly to animate, in response to the plurality of bonus game outcomes being presented, the graphical game interface to transition from the bonus game state to a base game state, wherein the transition includes visually updating meter indicia of the plurality of enhancement meters associated with the bonus game instance to respective reset values.

8. A method of operating a gaming machine of a gaming system, the gaming system including game-logic circuitry and a presentation assembly of the gaming machine in communication with the game-logic circuitry, the method comprising:
presenting, via the presentation assembly, a graphical game interface including a plurality of symbol positions and a plurality of enhancement meters, wherein each meter of the plurality of enhancement meters is associated with a respective update trigger event type and a respective game enhancement and includes meter indicia visually indicating a current meter value;
causing, by the game-logic circuitry, the presentation assembly to present one or more base game outcomes by populating, via animation of the graphical game interface, the plurality of symbol positions with randomly selected symbols;
in response to one or more update trigger events occurring within the one or more base game outcomes, causing, by the game-logic circuitry, the presentation assembly to visually update, for each of the one or more update trigger events, the meter indicia of the enhancement meter of the plurality of enhancement meters that is associated with the update trigger event;
in response to a bonus trigger event occurring within the one or more base game outcomes, causing, by the game-logic circuitry, the presentation assembly to visually transition the graphical game interface to a bonus game state for a bonus game instance including a plurality of bonus game outcomes, the bonus game instance including any active enhancement meter of the plurality of enhancement meters;
for each active enhancement meter, randomly selecting, by the game-logic circuitry, at least one bonus game outcome of the plurality of bonus game outcomes to apply the corresponding game enhancement at least partially as a function of the meter indicia of the active enhancement meter and one or more random values generated by a continuously-cycling random number generator of the game-logic circuitry; and
for each bonus game outcome associated with one or more active enhancement meters based on the random selection, causing, by the game-logic circuitry, the presentation assembly to (i) present an outcome sequence including animations associated with the game enhancements of the one or more active enhancement meters, and (ii) visually update the respective meter indicia of the one or more active enhancements in response to the outcome sequence.

9. The method of claim 8, wherein the active enhancement meters include any enhancement meter of the plurality of enhancement meters having a nonzero current meter value.

10. The method of claim 8, wherein the plurality of enhancement meters are updateable up to a maximum meter value, wherein the game enhancement of a first active enhancement meter having a current meter value equal to the maximum meter value is automatically applied to every bonus game outcome of the plurality of bonus game outcomes.

11. The method of claim 8, wherein bonus trigger events include detecting one or more bonus trigger symbols within the one or more base game outcomes, and wherein each enhancement meter of the plurality of enhancement meters is associated with a respective bonus trigger symbol type.

12. The method of claim 8 further comprising causing, by the game-logic circuitry, the presentation assembly to animate, in response to the plurality of bonus game outcomes being presented, the graphical game interface to transition from the bonus game state to a base game state, wherein the transition includes visually updating meter indicia of the plurality of enhancement meters associated with the bonus game instance to respective reset values.

13. The method of claim 12, wherein the reset values are the initially same for each enhancement meter of the plurality of enhancement meters, and wherein the method further comprises animating, in response to the transition to the base game state, a first enhancement meter of the plurality of enhancement meters to visually update the meter indicia of the first enhancement meter to a new value different from the reset value presented by at least one other enhancement meter of the plurality of enhancement meters.

14. The method of claim 8, wherein the game enhancements associated with the plurality of enhancement meters comprise at least one of additional symbol positions, additional wild symbols, additional modifier symbols, modifiers appliable to one or more awards, or symbol enhancements.

15. A gaming system comprising:
a gaming machine including a presentation assembly configured to present a graphical game interface including a plurality of symbol positions and a plurality of enhancement meters, wherein each meter of the plurality of enhancement meters is associated with a respective update trigger event type and a respective game enhancement and includes meter indicia visually indicating a current meter value; and
game-logic circuitry in communication with the presentation assembly, the game-logic circuitry configured to:
cause the presentation assembly to present one or more base game outcomes by populating, via animation of the graphical game interface, the plurality of symbol positions with randomly selected symbols;
in response to one or more update trigger events occurring within the one or more base game outcomes, cause the presentation assembly to visually update, for each of the one or more update trigger events, the meter indicia of the enhancement meter of the plurality of enhancement meters that is associated with the update trigger event;
in response to a bonus trigger event occurring within the one or more base game outcomes, cause the presentation assembly to visually transition the graphical game interface to a bonus game state for a bonus game instance including a plurality of bonus game outcomes, the bonus game instance including any active enhancement meter of the plurality of enhancement meters;
for each active enhancement meter, randomly select at least one bonus game outcome of the plurality of bonus game outcomes to apply the corresponding game enhancement at least partially as a function of the meter indicia of the active enhancement meter and one or more random values generated by a continuously-cycling random number generator of the game-logic circuitry; and
for each bonus game outcome associated with one or more active enhancement meters based on the random selection, cause the presentation assembly to (i) present an outcome sequence including animations associated with the game enhancements of the one or more active enhancement meters, and (ii) visually update the respective meter indicia of the one or more active enhancements in response to the outcome sequence.

16. The gaming system of claim 15, wherein the active enhancement meters include any enhancement meter of the plurality of enhancement meters having a nonzero current meter value.

17. The gaming system of claim 15, wherein the plurality of enhancement meters are updateable up to a maximum meter value, wherein the maximum meter value is equal to a total amount of outcomes within the plurality of bonus game outcomes.

18. The gaming system of claim 15, wherein the logic circuitry is further configured to cause the presentation assembly to animate, in response to the plurality of bonus game outcomes being presented, the graphical game interface to transition from the bonus game state to a base game state, wherein the transition includes visually updating meter indicia of the plurality of enhancement meters associated with the bonus game instance to respective reset values.

19. The gaming system of claim 18, wherein the reset values are the same for each enhancement meter of the plurality of enhancement meters.

20. The gaming system of claim 15, wherein the game enhancements associated with the plurality of enhancement meters comprise at least one of additional symbol positions, additional wild symbols, additional modifier symbols, modifiers appliable to one or more awards, or symbol enhancements.
